(19) United States
(12) Patent Application Publication
(10) Pub. No.: US 2018/0231704 A1
(43) Pub. Date: Aug. 16, 2018

(54) POLARIZING FILM, IMAGE DISPLAY APPARATUS, AND METHOD OF PRODUCING POLARIZING FILM

(71) Applicant: NITTO DENKO CORPORATION, Osaka (JP)

(72) Inventors: Tomonori Ueno, Ibaraki-shi (JP); Yasutaka Ishihara, Ibaraki-shi (JP); Atsushi Kishi, Ibaraki-shi (JP)

(73) Assignee: NITTO DENKO CORPORATION, Osaka (JP)

(21) Appl. No.: 15/886,011

(22) Filed: Feb. 1, 2018

(30) Foreign Application Priority Data
Feb. 10, 2017 (JP) 2017-022682
Dec. 4, 2017 (JP) 2017-232237

(51) Int. Cl. G02B 5/30

(52) U.S. Cl. CPC G02B 5/3033

(57) ABSTRACT

A polarizing film according to an embodiment of the present invention includes a polarizer and a support. The support is formed on at least one surface of the polarizer. The support has a pattern structure. The method of producing a polarizing film includes a step of forming a pattern of a resin material on at least one surface of a polarizer; and curing the resin material to provide a support having a pattern structure.

### BACKGROUND OF THE INVENTION

This application claims priority under 35 U.S.C Section 119 to Japanese Patent Application No. 2017-022682 filed on Feb. 10, 2017 and Japanese Patent Application No. 2017-232237 filed on Dec. 4, 2017 which are herein incorporated by reference.

### 1. Field of the Invention

The present invention relates to a polarizing film, an image display apparatus, and a method of producing a polarizing film.

### 2. Description of the Related Art

A related-art and general polarizing plate to be used in an image display apparatus includes a polarizer and a protective film arranged on one side, or each of both sides, of the polarizer. The polarizer is obtained by, for example, subjecting a hydrophilic polymer film, such as a polyvinyl alcohol-based film, to dyeing treatment with a dichroic substance, such as iodine or a dichroic dye, and stretching treatment. In addition, in recent years, along with a demand for the thinning of an optical member to be used in an image display apparatus, the following technology has been known (Japanese Patent Application Laid-open No. 2012-73580). A thin polarizer having a thickness of 10 μm or less is obtained by: forming a polyvinyl alcohol-based resin layer on one side of a resin substrate; and subjecting a laminate of the resin substrate and the polyvinyl alcohol-based resin layer to dyeing treatment and stretching treatment.

However, the related-art polarizing plate obtained by laminating the protective film on the polarizer has not sufficiently met the demand for thinning, and hence a further thinning has been required. Meanwhile, the thin polarizer alone has low rigidity (low flexural strength), and hence does not have any self-supportability. Therefore, the polarizer alone has low processability.

### SUMMARY OF THE INVENTION

The present invention has been made to solve the conventional problems, and a primary object of the present invention is to provide a thin polarizing film that has self-supportability and is excellent in processability, an image display apparatus including the polarizing film, and a method of producing a polarizing film.

An polarizing film according to an embodiment of the present invention includes: a polarizer; and a support formed on at least one surface of the polarizer, wherein the support has a pattern structure.

In one embodiment of the present invention, the polarizer has a thickness of 15 μm or less.

In one embodiment of the present invention, the support has at least one structure selected from the group consisting of a honeycomb structure, a truss structure, a rigid-frame structure, a stripe structure, and a circle structure.

In one embodiment of the present invention, the support has a thickness of from 1 μm to 15 μm.

In one embodiment of the present invention, the support has a width in a plan view of from 500 μm to 3,000 μm.

In one embodiment of the present invention, the support has optical isotropy.

In one embodiment of the present invention, the polarizing film further comprising, on the one surface of the polarizer, an embedding resin layer configured to embed the support therein.

In one embodiment of the present invention, the support has a compressive modulus of elasticity at 23° C. of from 0.01 GPa to 8.0 GPa.

According to another aspect of the present invention, an image display apparatus is provided. The image display apparatus includes the polarizing film.

According to still another aspect of the present invention, a method of producing a polarizing film is provided. The method of producing a polarizing film includes a step of forming a pattern of a resin material on at least one surface of a polarizer; and curing the resin material to provide a support having a pattern structure.

According to the present invention, the thin polarizing film that has self-supportability and is excellent in processability, the image display apparatus including the polarizing film, and the method of producing a polarizing film can be provided.

### BRIEF DESCRIPTION OF THE DRAWINGS

FIG. 1 is a plan view of a polarizing film according to one embodiment of the present invention.

FIG. 2 is a sectional view of the polarizing film according to one embodiment of the present invention.

FIG. 3 is a plan view of the polarizing film according to another embodiment of the present invention.

FIG. 4 is a plan view of the polarizing film according to still another embodiment of the present invention.

FIG. 5 is a plan view of the polarizing film according to still another embodiment of the present invention.

FIG. 6 is a plan view of the polarizing film according to still another embodiment of the present invention.

FIG. 7 is a sectional view of a polarizing film according to still another embodiment of the present invention.

FIG. 8 is a sectional view of a polarizing film according to still another embodiment of the present invention.

FIG. 9 is a schematic view for illustrating a torsion test.

FIG. 10 is a schematic view for illustrating a U-shape folding test.

### DESCRIPTION OF THE EMBODIMENTS

Embodiments of the present invention are described below. However, the present invention is not limited to these embodiments.

A. Entire Configuration of Polarizing Film

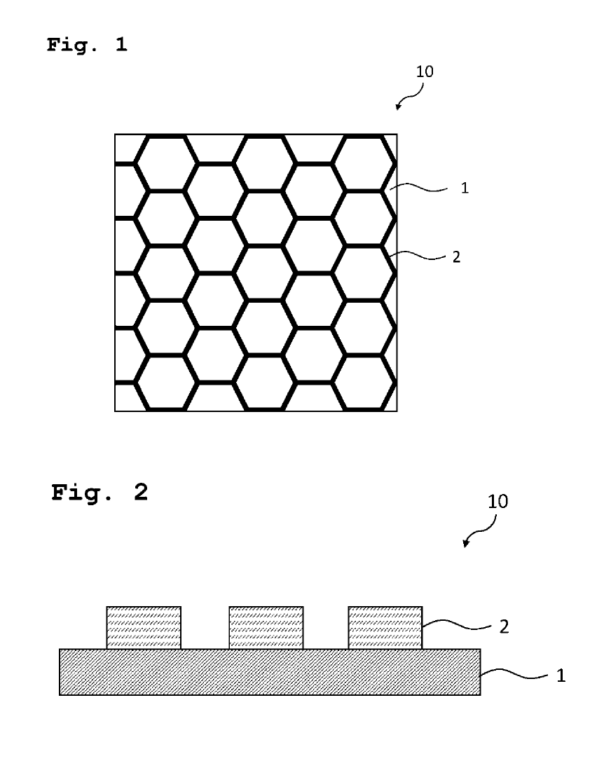

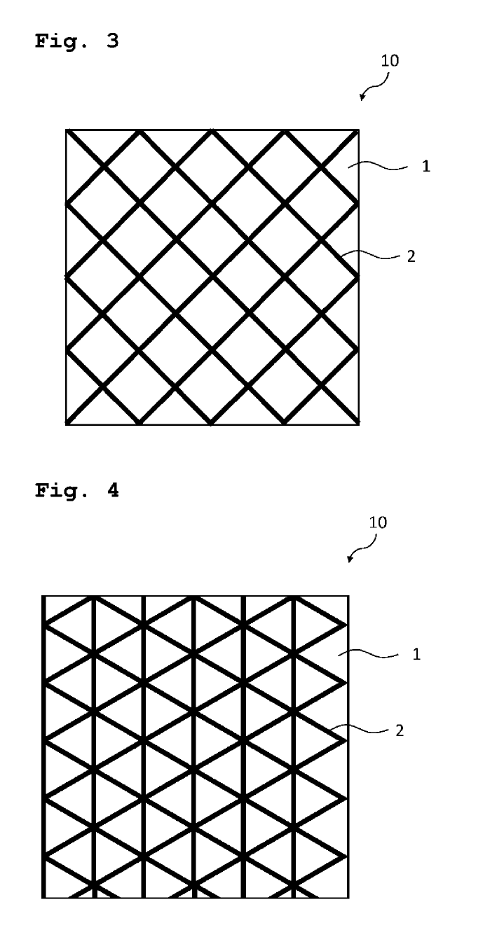

FIG. 1 is a plan view of a polarizing film according to one embodiment of the present invention. FIG. 2 is a sectional view of the polarizing film according to one embodiment of the present invention. As illustrated in FIG. 2, a polarizing film 10 includes a polarizer 1 and a support 2 formed on one surface of the polarizer 1. The polarizing film 10 may have a sheet-like shape, or may have an elongated shape. The thickness of the polarizer 1 is typically 15 μm or less. The thickness of the support 2 is typically from 1 μm to 15 μm, and the width of the support 2 in a plan view is typically from 500 μm to 3,000 μm. It is preferred that the support 2 be transparent, and it is more preferred that the support 2 be transparent and substantially have optical isotropy. The support 2 has a pattern structure, and typically has such a honeycomb structure as illustrated in FIG. 1 as the pattern structure. The polarizing film 10 has high rigidity (high flexural strength) as compared to a single polarizer, and hence has self-supportability. Therefore, the polarizing film 10 can be suppressed from curling, and is excellent in handleability and processability. In addition, the polarizing film 10 can maintain its film shape despite the fact that the film is thinner than a related-art polarizing plate.

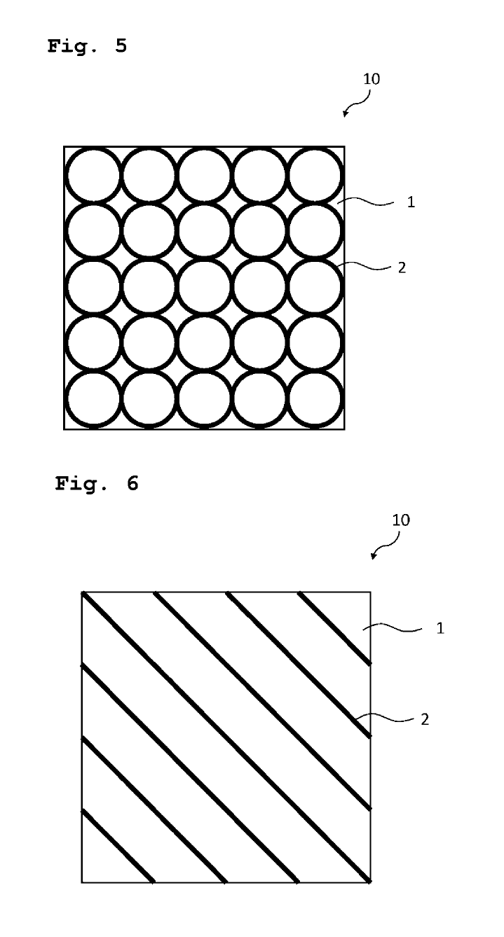

FIG. 3 to FIG. 6 are each a plan view of the polarizing film according to another embodiment of the present invention. The support may have such a rigid-frame structure as illustrated in FIG. 3, may have such a truss structure as illustrated in FIG. 4, may have such a circle structure (structure in which circles are arranged in a matrix manner) as illustrated in FIG. 5, or may have such a stripe structure as illustrated in FIG. 6. In the case where the pattern-like support 2 is formed on the surface of the polarizer 1 as described above, the usage amount of a material forming the support can be reduced as compared to that in the case where a support is formed on the entire surface of the polarizer 1.

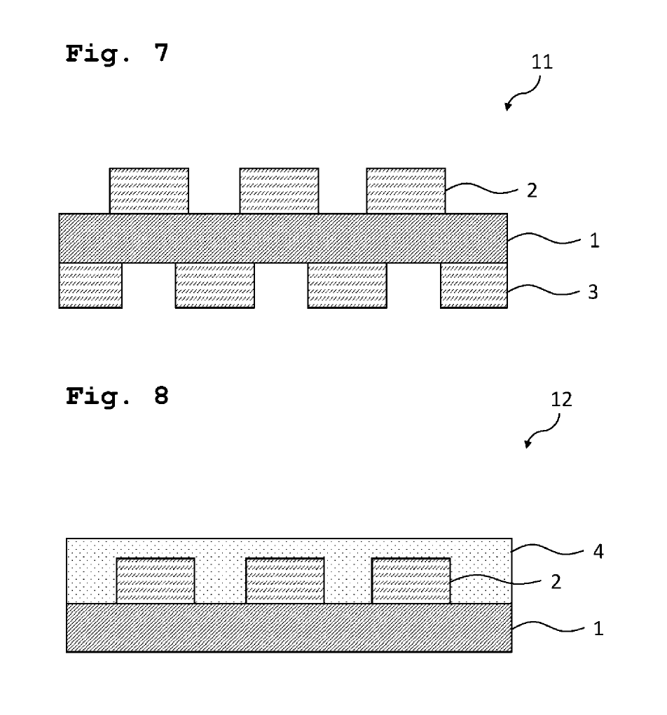

FIG. 7 is a sectional view of a polarizing film according to still another embodiment of the present invention. As illustrated in FIG. 7, a polarizing film 11 includes the support 2 (hereinafter sometimes referred to as “first support 2”) on one surface of the polarizer 1, and includes a support 3 (hereinafter sometimes referred to as “second support 3”) on the other surface of the polarizer 1. The second support 3 has a pattern structure. The pattern structure of the second support 3 may be identical to or different from the pattern structure of the first support 2. When the pattern structure of the first support 2 and the pattern structure of the second support 3 are identical to each other, the first support 2 and the second support 3 are preferably arranged so that the area of portions overlapping each other in a plan view may be as small as possible as illustrated in FIG. 7. Thus, the polarizing film 11 has rigidity and processability higher than those of a polarizing film having a support only on one surface of a polarizer.

FIG. 8 is a sectional view of a polarizing film according to still another embodiment of the present invention. As illustrated in FIG. 8, a polarizing film 12 includes, on one surface of the polarizer 1, an embedding resin layer 4 configured to embed the support 2 therein. Thus, a step formed by the support 2 can be smoothened. Further, the embedding resin layer 4 covers an exposed portion of the polarizer 1, and hence the surface of the polarizer 1 can be protected. Two or more of the above-mentioned embodiments may be combined.

The polarizer 1 typically has an absorption axis. The support 2 preferably includes a portion intersecting the absorption axis of the polarizer 1 in a plan view. Specifically, in the example illustrated in FIG. 1, the support 2 has a honeycomb structure, and at least one side of a hexagon forming the honeycomb structure intersects the absorption axis of the polarizer 1 in a plan view. It is more preferred that when a path from any appropriate point in one end of the sheet-like polarizing film 10 to the other end thereof is followed along a direction parallel to the absorption axis of the polarizer 1, the path intersect the support 2 at least one site. When a crack occurs in a conventional polarizer, the crack may advance along the direction of the absorption axis of the polarizer so as to tear the polarizer. In contrast, the polarizing film 10 of the present invention includes the support 2 and the support 2 includes the portion intersecting the absorption axis of the polarizer 1 in a plan view, and hence the support 2 can suppress the advance of a crack (tear) in the polarizer 1.

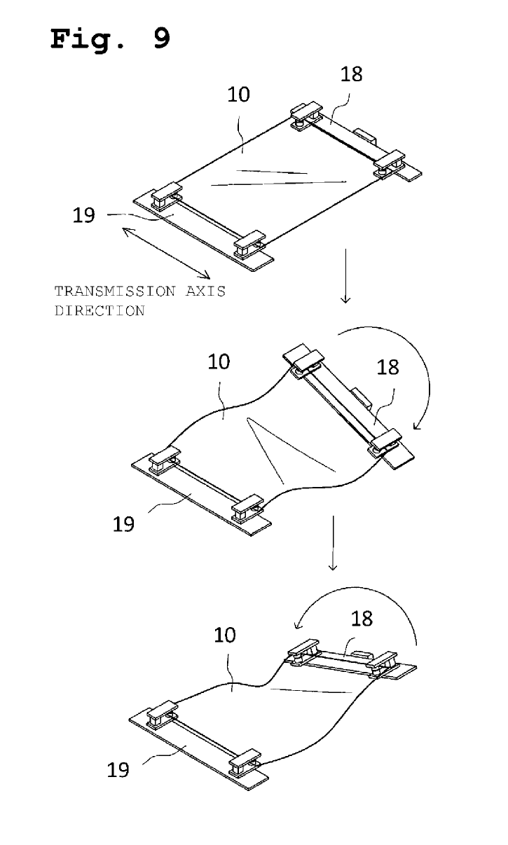

The polarizing film is preferably free of a crack extending from one end of the polarizer to the other end thereof along the absorption axis direction thereof, the fracture of the polarizing film, and light leakage after having been subjected to a torsion test. The torsion test may be performed with a no-tension torsion testing machine for a planar object (product name: MAIN BODY TCDM111LH) and a jig (No-tension Torsion Test Jig for Planar Object) manufactured by Yuasa System. Co., Ltd. by the following procedure. As illustrated in FIG. 9, both short sides of the sheet-like polarizing film 10 measuring 120 mm (absorption axis direction) by 80 mm (transmission axis direction) are sandwiched and fixed with twisting clips 18 and 19 of the testing machine. After that, while one of the short sides is fixed with the clip 19, the clip 18 on the side of the other short side is twisted under the following conditions.

Twisting speed: 10 rpm

Twisting angle: 45°

Number of times of twisting: 100 times

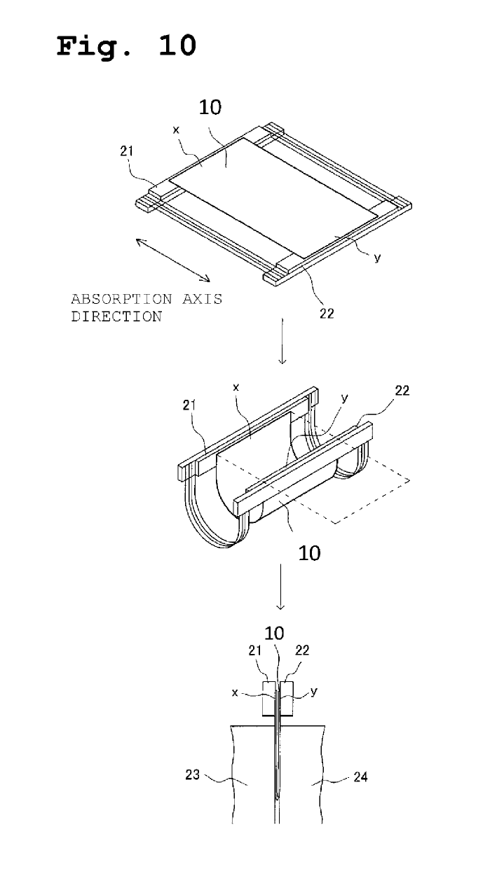

The polarizing film is preferably free of the rupture of the polarizer, the fracture of the polarizing film, and light leakage after having been subjected to a U-shape folding test. The U-shape folding test may be performed with a no-tension U-shape folding testing machine for a planar object (product name: MAIN BODY DLDM111LH) and a jig (No-tension U-shape Folding Test Jig for Planar Object) manufactured by Yuasa System Co., Ltd. by the following procedure. As illustrated in FIG. 10, both end portions x and y (50 mm) of the sheet-like polarizing film 10 measuring 100 mm (absorption axis direction) by 50 mm (transmission axis direction) are fixed to supporting portions 21 and 22 of the testing machine with double-sided tapes (not shown). After that, such folding that one surface side (first surface) of the polarizing film 10 has an inward U-shape is performed under the following conditions to bend the polarizing film 10 (bending on the first surface side in the transmission axis direction). In the U-shape folding, a bending R (bending radius) is set to 3 mm, and the polarizing film 10 is bent from a planar state until one half of the film in a two-folded state is brought into contact with the other half thereof. In the bending, both the end portions x and y are brought into contact with each other by the operation of the supporting portions, and the other portions of the polarizing film 10 are brought into contact with each other in such a manner that the portions are sandwiched between plate portions 23 and 24, which are separately arranged, from both of their outsides without any tension. In addition, in the bending by the folding, such folding that the other surface side (second surface) of the polarizing film 10 has an inward U-shape is similarly performed (bending on the second surface side in the transmission axis direction).

Folding speed: 30 rpm

Bending R: 3 mm

Number of times of folding: 100 times

B. Polarizer

Any appropriate polarizer may be adopted as the polarizer. For example, a resin film forming the polarizer may be a single-layer resin film, or may be a laminate of two or more layers.

Specific examples of the polarizer including a single-layer resin film include: a polarizer obtained by subjecting a hydrophilic polymer film, such as a polyvinyl alcohol (PVA)-based film, a partially formalized PVA-based film, or an ethylene-vinyl acetate copolymer-based partially saponified film, to dyeing treatment with a dichroic substance, such as iodine or a dichroic dye, and stretching treatment; and a polyene-based alignment film, such as a dehydration-treated product of PVA or a dehydrochlorination-treated product of polyvinyl chloride. A polarizer obtained by dyeing the PVA-based film with iodine and uniaxially stretching the resultant is preferably used because the polarizer is excellent in optical characteristics.

The dyeing with iodine is performed by, for example, immersing the PVA-based film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching has been performed. The PVA-based film is subjected to swelling treatment, cross-linking treatment, washing treatment, drying treatment, or the like as required. For example, when the PVA-based film is immersed in water to be washed with water before the dyeing, contamination or an antiblocking agent on the surface of the PVA-based film can be washed off. In addition, the PVA-based film is swollen and hence dyeing unevenness or the like can be prevented.

The polarizer obtained by using the laminate is specifically, for example, a polarizer obtained by using a laminate of a resin substrate and a PVA-based resin layer (PVA-based resin film) laminated on the resin substrate, or a laminate of a resin substrate and a PVA-based resin layer formed on the resin substrate through application. The polarizer obtained by using the laminate of the resin substrate and the PVA-based resin layer formed on the resin substrate through application may be produced by, for example, a method involving: applying a PVA-based resin solution to the resin substrate; drying the solution to form the PVA-based resin layer on the resin substrate, thereby providing the laminate of the resin substrate and the PVA-based resin layer; and stretching and dyeing the laminate to turn the PVA-based resin layer into the polarizer. In this embodiment, the stretching typically includes the stretching of the laminate under a state in which the laminate is immersed in an aqueous solution of boric acid. The stretching may further include the aerial stretching of the laminate at high temperature (e.g., 95° C. or more) before the stretching in the aqueous solution of boric acid as required. The resultant laminate of the resin substrate and the polarizer may be used as it is (i.e., the resin substrate may be used as a protective layer for the polarizer). Alternatively, a product obtained as described below may be used: the resin substrate is peeled from the laminate of the resin substrate and the polarizer, and any appropriate protective layer in accordance with purposes is laminated on the peeling surface. Details of such method of producing a polarizer are described in, for example, JP 2012-73580 A. The entire description of the laid-open publication is incorporated herein by reference.

The thickness of the polarizer is preferably 15 μm or less, more preferably from 2 μm to 10 μm, particularly preferably from 3 μm to 8 μm. When the thickness of the polarizer falls within such range, curling at the time of heating can be satisfactorily suppressed, and besides, satisfactory external appearance durability at the time of heating is obtained.

The polarizer preferably shows absorption dichroism at any wavelength in the wavelength range of from 380 nm to 780 nm. The single layer transmittance of the polarizer is preferably from 42.0% to 46.0%, more preferably from 44.5% to 46.0%. The polarization degree of the polarizer is preferably 97.0% or more, more preferably 99.0% or more, still more preferably 99.9% or more.

C. Support

As described above, the support has a pattern structure. The support preferably has at least one structure selected from the group consisting of a honeycomb structure, a truss structure, a rigid-frame structure, a stripe structure, and a circle structure. The support more preferably has a honeycomb structure, a truss structure, or a circle structure, and particularly preferably has a honeycomb structure or a circle structure. This is because of the following reason: in the case where the support has a honeycomb structure, a truss structure, or a circle structure, when the polarizing film receives a stress in one direction, the stress can be dispersed in a direction different from the direction, and as a result, the occurrence of a crack in the polarizer can be suppressed.

It is preferred that the support be transparent and substantially have optical isotropy. The phrase “substantially have optical isotropy” as used herein means that a retardation value is so small as to have substantially no influences on the optical characteristics of the polarizing film. For example, each of the in-plane retardation Re(550) and thickness direction retardation Rth(550) of the support is preferably 20 nm or less, more preferably 10 nm or less. The term “Re(550)” as used herein refers to an in-plane retardation measured at 23° C. with light having a wavelength of 550 nm. The Re(550) is determined from the equation Re(550)=(nx−ny)×d when the thickness of a layer (film) is represented by d (nm). The “Rth(550)” refers to a thickness direction retardation measured at 23° C. with light having a wavelength of 550 nm. The Rth (550) is determined from the equation “Rth(550)=(nx−nz)×d” when the thickness of a layer (film) is represented by d (nm). “nx” represents a refractive index in a direction in which an in-plane refractive index is maximum (that is, slow axis direction), “ny” represents a refractive index in a direction perpendicular to the slow axis in the plane (that is, fast axis direction), and “nz” represents a refractive index in a thickness direction.

As described above, the thickness of the support is preferably from 1 μm to 15 μm, and the thickness is more preferably from 3 μm to 8 μm. The ratio (t2/t1) of the thickness (t2) of the support to the thickness (t1) of the polarizer is preferably from 0.13 to 5.00, more preferably from 0.38 to 4.00, still more preferably from 0.63 to 3.33.

The compressive modulus of elasticity of the support at 23° C. is preferably from 0.01 GPa to 8.0 GPa, more preferably from 0.02 GPa to 6.0 GPa. In this case, the processability and flexibility of the polarizing film can be improved while the advance of a crack in the polarizer is suppressed.

The support may be formed by any appropriate material and method as long as the support satisfies the above-mentioned configuration and has sufficient adhesiveness with the polarizer. The adhesiveness of the support with the polarizer may be evaluated in conformity with the cross-cut peeling test of JIS K5400. The adhesiveness of the support with the polarizer is preferably as follows: in the cross-cut peeling test (number of grids: 100), the number of peeled grids is 0.

In one embodiment, the support having a pattern structure may be formed by: forming the pattern of a resin material or an application liquid containing the resin material on the surface of the polarizer; and curing (or solidifying) the resin material. In another embodiment, the support may be formed by depositing an inorganic oxide, such as SiO₂, from the vapor onto the surface of the polarizer.

Any appropriate material may be used as the resin material as long as the effects of the present invention are obtained. Examples of the resin material may include a polyester-based resin, a polyether-based resin, a polycarbonate-based resin, a polyurethane-based resin, a silicone-based resin, a polyamide-based resin, a polyimide-based resin, a PVA-based resin, an acrylic resin, an epoxy-based resin, and a fluorine-based resin. Those resin materials may be used alone or in combination thereof (e.g., as a blend or copolymer thereof).

A method of forming the pattern of the resin material or the application liquid on the surface of the polarizer is not particularly limited. Examples of the method include printing, photolithography, an inkjet method, a nozzle, and die coating. The pattern of the resin material or the application liquid is preferably formed by printing. As a method of printing the application liquid in a pattern shape, there are given, for example, a relief printing method, a direct gravure printing method, an intaglio printing method, a planographic printing method, and a stencil printing method. The application liquid may contain any appropriate other component in addition to the resin material to the extent that the effects of the present invention are not impaired. Examples of such other component include a resin component other than the resin material serving as a main component, a tackifier, an inorganic filler, an organic filler, metal powder, a pigment, a foil-shaped material, a softener, an age resistor, a conductive agent, a UV absorber, an antioxidant, a light stabilizer, a surface lubricating agent, a leveling agent, a corrosion inhibitor, a heat stabilizer, a polymerization inhibitor, a lubricant, a solvent, and a catalyst.

Conditions under which the resin material (application liquid) is cured (or solidified) may be appropriately set in accordance with, for example, the kind of the resin material and the composition of a composition. For example, the resin material may be cured (or solidified) by drying, active energy ray curing, or thermal curing.

D. Embedding Resin Layer

As described above, the embedding resin layer embeds the support formed on one surface of the polarizer therein. The thickness of the embedding resin layer is larger than the thickness of the support, and is preferably from 3 μm to 150 μm, more preferably from 5 μm to 100 μm. The embedding resin layer may be any appropriate functional layer formed in accordance with characteristics required of the polarizing film. Examples of the functional layer include a hard coat layer, a pressure-sensitive adhesive layer, and a transparent optical pressure-sensitive adhesive layer. When the embedding resin layer is a hard coat layer, its thickness is, for example, from 5 μm to 15 μm, when the embedding resin layer is a pressure-sensitive adhesive layer, its thickness is, for example, from 5 μm to 30 μm, and when the embedding resin layer is a transparent optical pressure-sensitive adhesive layer, its thickness is, for example, from 25 μm to 125 μm. It is preferred that the embedding resin layer be transparent and substantially have optical isotropy.

The embedding resin layer may be formed by any appropriate material and method as long as the layer has sufficient adhesiveness with each of the polarizer and the support. In one embodiment, the embedding resin layer may be formed by using a resin material different in kind from that of the support. The embedding resin layer may be formed by: forming a resin layer on the surface of the polarizer so that the layer may embed the support therein; and curing the resin layer.

A method of forming the resin layer on the surface of the polarizer is not particularly limited. In one embodiment, the resin layer may be formed by applying an application liquid containing the resin material to the surface of the polarizer. Any appropriate application method may be used as an application method. Specific examples thereof include a curtain coating method, a dip coating method, a spin coating method, a print coating method, a spray coating method, a slot coating method, a roll coating method, a slide coating method, a blade coating method, a gravure coating method, and a wire bar method. Curing conditions may be appropriately set depending on, for example, the kind of the resin material to be used and the composition of the composition. The application liquid may contain any appropriate other component in addition to the resin material to the extent that the effects of the present invention are not impaired. Examples of such other component include a resin component other than the resin material serving as a main component, a tackifier, an inorganic filler, an organic filler, metal powder, a pigment, a foil-shaped material, a softener, an age resistor, a conductive agent, a UV absorber, an antioxidant, a light stabilizer, a surface lubricating agent, a leveling agent, a corrosion inhibitor, a heat stabilizer, a polymerization inhibitor, a lubricant, a solvent, and a catalyst.

E. Second Support

As described above, when the pattern structure of the first support and the pattern structure of the second support are identical to each other, the second support is preferably arranged so that the area of a portion overlapping the first support in a plan view may be as small as possible. The configuration, function, and the like of the second support are as described in the section C regarding the support (first support).

F. Other Optical Film and Image Display Apparatus

The polarizing film may be used as an optical laminate obtained by laminating any other optical film, such as a retardation film, on the film. In addition, the polarizing film described in the section A to the section E and the optical laminate are applicable to an image display apparatus, such as a liquid crystal display apparatus. Therefore, the present invention includes an image display apparatus using the polarizing film. An image display apparatus according to an embodiment of the present invention includes the polarizing film described in the section A to the section E.

### EXAMPLES

The present invention is described below byway of Examples, but the present invention is not limited to these Examples. In Examples, “part (s)” and “%” are by weight unless otherwise specified. All room-temperature standing conditions below are 23° C. and 65% RH unless otherwise specified.

1. Production of Polarizer

### Production Example 1

One surface of an amorphous isophthalic acid-copolymerized polyethylene terephthalate (IPA-copolymerized PET) film (thickness: 100 μm) substrate having a water absorption ratio of 0.75% and a Tg of 75° C. was subjected to corona treatment. An aqueous solution containing polyvinyl alcohol (polymerization degree: 4,200, saponification degree: 99.2 mol %) and acetoacetyl-modified PVA (polymerization degree: 1,200, acetoacetyl modification degree: 4.6%, saponification degree: 99.0 mol % or more, manufactured by The Nippon Synthetic Chemical Industry Co., Ltd., product name: “GOHSEFIMER Z200”) at a ratio of 9:1 was applied to the corona-treated surface at 25° C., and was dried to forma PVA-based resin layer having a thickness of 11 μm. Thus, a laminate was produced. The resultant laminate was subjected to free-end uniaxial stretching in an oven at 120° C. between rolls having different peripheral speeds in its longitudinal direction (lengthwise direction) to 2.0 times (aerial auxiliary stretching treatment). Next, the laminate was immersed in an insolubilizing bath having a liquid temperature of 30° C. (aqueous solution of boric acid obtained by compounding 100 parts by weight of water with 4 parts by weight of boric acid) for 30 seconds (insolubilizing treatment). Next, the laminate was immersed in a dyeing bath having a liquid temperature of 30° C. while an iodine concentration and an immersion time were adjusted so that a polarizer to be obtained had a predetermined transmittance. In this production example, the laminate was immersed in an aqueous solution of iodine, which was obtained by compounding 100 parts by weight of water with 0.2 part by weight of iodine and with 1.0 part by weight of potassium iodide, for 60 seconds (dyeing treatment). Next, the laminate was immersed in a cross-linking bath having a liquid temperature of 30° C. (aqueous solution of boric acid obtained by compounding 100 parts by weight of water with 3 parts by weight of potassium iodide and with 3 parts by weight of boric acid) for 30 seconds (cross-linking treatment). After that, while being immersed in an aqueous solution of boric acid having a liquid temperature of 70° C. (aqueous solution obtained by compounding 100 parts by weight of water with 4 parts by weight of boric acid and with 5 parts by weight of potassium iodide), the laminate was subjected to uniaxial stretching between rolls having different peripheral speeds in its longitudinal direction (lengthwise direction) so that the total stretching ratio became 5.5 times (underwater stretching treatment). After that, the laminate was immersed in a washing bath having a liquid temperature of 30° C. (aqueous solution obtained by compounding 100 parts by weight of water with 4 parts by weight of potassium iodide) (washing treatment). Thus, a polarizer laminate A including a polarizer having a thickness of 5 μm was obtained.

### Production Example 2

A polarizer laminate B including a polarizer having a thickness of 7 μm was produced in the same manner as in Production Example 1 except that the thickness of the PVA-based resin layer after the application and the drying was changed to 15 μm.

### Production Example 3

A 30-micrometer-thick polyvinyl alcohol film having an average polymerization degree of 2,400 and a saponification degree of 99.9 mol % was immersed in warm water at 30° C. for 60 seconds to be swollen. Next, the film was immersed in an aqueous solution containing a mixture of iodine and potassium iodide (weight ratio “iodine/potassium iodide”=0.5/8) at a concentration of 0.3%, and was dyed while being stretched to 3.5 times. After that, the film was stretched in an aqueous solution of a boric acid ester at 65° C. so that the total stretching ratio became 6 times. After the stretching, the film was dried in an oven at 40° C. for 3 minutes to provide a PVA-based polarizer C. The thickness of the resultant polarizer C was 12 μm.

2. Production of Support Formation Material

### Production Example 4

An application agent A whose solid content concentration had been adjusted so that the agent could be applied in a designated thickness was obtained by adding 20 parts of N-(2-hydroxyethyl)acrylamide (manufactured by Kohjin Co., Ltd., “HEAR”) and 3 parts of a photoinitiator (manufactured by BASF, “IRGACURE 907”) to 100 parts of a urethane acrylate oligomer (manufactured by The Nippon Synthetic Chemical Industry Co., Ltd., “SHIKOH UV-7560B”), and using methyl isobutyl ketone as a solvent.

### Production Example 5

An application agent B whose solid content concentration had been adjusted so that the agent could be applied in a designated thickness was obtained by adding 20 parts of N-(2-hydroxyethyl)acrylamide (manufactured by Kohjin Co., Ltd., “HEAR”) and 3 parts of a photoinitiator (manufactured by BASF, “IRGACURE 907”) to 100 parts of a urethane acrylate oligomer (manufactured by The Nippon Synthetic Chemical Industry Co., Ltd., “SHIKOH UV-7000B”), and using methyl isobutyl ketone as a solvent.

### Production Example 6

An application agent C whose solid content concentration had been adjusted so that the agent could be applied in a designated thickness was obtained by adding 20 parts of N-(2-hydroxyethyl)acrylamide (manufactured by Kohjin Co., Ltd., “HEAR”) and 3 parts of a photoinitiator (manufactured by BASF, “IRGACURE 907”) to 100 parts of a urethane acrylate oligomer (manufactured by The Nippon Synthetic Chemical Industry Co., Ltd., “SHIKOHUV-3520TL”), and using methyl isobutyl ketone as a solvent.

### Production Example 7

An application agent D whose solid content concentration had been adjusted so that the agent could be applied in a designated thickness was obtained by adding 20 parts of N-(2-hydroxyethyl)acrylamide (manufactured by Kohjin Co., Ltd., “HEAR”) and 3 parts of a photoinitiator (manufactured by BASF, “IRGACURE 907”) to 100 parts of a urethane acrylate oligomer (manufactured by The Nippon Synthetic Chemical Industry Co., Ltd., “SHIKOH UV-6640B”), and using methyl isobutyl ketone as a solvent.

### Production Example 8

An application agent E whose solid content concentration had been adjusted so that the agent could be applied in a designated thickness was obtained by using a UV-curable screen ink (manufactured by Teikoku Printing Inks Mfg. Co., Ltd., “UV FIL SCREEN INK 611 WHITE” (solid content: 76%)) and a diluent solvent (manufactured by Teikoku Printing Inks Mfg. Co., Ltd., “RE-806 REDUCER”).

### Production Example 9

An application agent F whose solid content concentration had been adjusted so that the agent could be applied in a designated thickness was obtained by adding 20 parts of N-(2-hydroxyethyl)acrylamide (manufactured by Kohjin Co., Ltd., “HEAR”) and 3 parts of a photoinitiator (manufactured by BASF, “IRGACURE 907”) to 100 parts of a urethane acrylate oligomer (manufactured by The Nippon Synthetic Chemical Industry Co., Ltd., “SHIKOH UV-1700”), and using methyl isobutyl ketone as a solvent.

### Example 1

The application agent A was applied to the polarizer-side surface of the polarizer laminate A in a honeycomb manner so that its thickness after curing became 7 μm, followed by its drying under the conditions of 60° C. and 120 seconds. A precision desktop printing machine (manufactured by Newlong Seimitsu Kogyo Co., Ltd., “Model DP-320”) and a screen printing plate molded into a honeycomb-like pattern (mesh size: #500, wire diameter: 18 μm, thickness: 38 μm, emulsion thickness: 10 μm) were used in the application of the application agent.

After that, the application agent was irradiated with UV light having an integrated light quantity of 500 mJ/cm² from a high-pressure mercury lamp to be cured. Thus, a support (first support) having a honeycomb structure (line width: 1.0 mm, length of one side of a regular hexagon: 4.0 mm) was formed. Next, a surface protective film (manufactured by Nitto Denko Corporation, “RP301”) was bonded onto the support, and the amorphous PET substrate of the polarizer laminate A was peeled. After that, the surface protective film was peeled. Thus, a polarizing film 1 including the polarizer and the first support was produced.

### Example 2

A polarizing film 2 was produced in the same manner as in Example 1 except that the application agent B was used as an application agent.

### Example 3

A polarizing film 3 was produced in the same manner as in Example 1 except that the application agent C was used as an application agent.

### Example 4

A polarizing film 4 was produced in the same manner as in Example 1 except that the application agent D was used as an application agent.

### Example 5

A polarizing film 5 was produced in the same manner as in Example 1 except that the application agent E was used as an application agent.

### Example 6

The application agent E was applied to the polarizer-side surface of the polarizer laminate A in a honeycomb manner so that its thickness after curing became 7 μm, followed by its drying under the conditions of 60° C. and 120 seconds. A precision desktop printing machine (manufactured by Newlong Seimitsu Kogyo Co., Ltd., “Model DP-320”) and a screen printing plate molded into a honeycomb-like pattern (mesh size: #500, wire diameter: 18 μm, thickness: 38 μm, emulsion thickness: 10 μm) were used in the application of the application agent.

After that, the application agent was irradiated with UV light having an integrated light quantity of 500 mJ/cm² from a high-pressure mercury lamp to be cured. Thus, a support (first support) having a honeycomb structure (line width: 1.0 mm, length of one side of a regular hexagon: 4.0 mm) was formed. Next, a surface protective film (manufactured by Nitto Denko Corporation, “RP301”) was bonded onto the support, and the amorphous PET substrate of the polarizer laminate A was peeled.

Next, a second support having a honeycomb structure (line width: 1.0 mm, length of one side of a regular hexagon: 4.0 mm) was formed by using the application agent E on the surface of the polarizer opposite to the surface on which the first support had been formed in the same manner as in the first support so as to overlap the first support in a plan view. After that, the surface protective film was peeled. Thus, a polarizing film 6 including the polarizer and the first and second supports was produced.

### Example 7

A polarizing film 7 was produced in the same manner as in Example 6 except that the thickness of each of the first and second supports was set to 3 μm.

### Example 8

A polarizing film 8 was produced in the same manner as in Example 6 except that the thickness of each of the first and second supports was set to 5 μm.

### Example 9

A polarizing film 9 was produced in the same manner as in Example 6 except that the thickness of each of the first and second supports was set to 14 μm.

### Example 10

A polarizing film 10 was produced in the same manner as in Example 6 except that the second support was formed so that an apex of a regular hexagon of the second support overlapped the center of a regular hexagon of the first support in a plan view (the positions of the first support and the second support deviated from each other in a plan view).

### Example 11

A polarizing film 11 and a polarizing film 11 with a pressure-sensitive adhesive layer were each produced in the same manner as in Example 10 except that the polarizer laminate B was used as a polarizer laminate.

### Example 12

The application agent E was applied to one side of the polarizer C in a honeycomb manner so that its thickness after curing became 7 μm, followed by its drying under the conditions of 60° C. and 120 seconds. A precision desktop printing machine (manufactured by Newlong Seimitsu Kogyo Co., Ltd., “Model DP-320”) and a screen printing plate molded into a honeycomb-like pattern (mesh size: #500, wire diameter: 18 μm, thickness: 38 μm, emulsion thickness: 10 μm) were used in the application of the application agent.

After that, the application agent was irradiated with UV light having an integrated light quantity of 500 mJ/cm² from a high-pressure mercury lamp to be cured. Thus, a support (first support) having a honeycomb structure (line width: 1.0 mm, length of one side of a regular hexagon: 4.0 mm) was formed. Next, a surface protective film (manufactured by Nitto Denko Corporation, “RP301”) was bonded onto the support.

Next, a second support having a honeycomb structure (line width: 1.0 mm, length of one side of a regular hexagon: 4.0 mm) was formed by using the application agent E on the surface of the polarizer C opposite to the surface on which the first support had been formed in the same manner as in the first support so that an apex of a regular hexagon of the second support overlapped the center of a regular hexagon of the first support in a plan view (the positions of the first support and the second support deviated from each other in a plan view). After that, the surface protective film was peeled. Thus, a polarizing film 12 including the polarizer and the first and second supports was produced.

### Example 13

A polarizing film 13 was produced in the same manner as in Example 10 except that the line width of the honeycomb structure of each of the first and second supports was set to 1.8 mm.

### Example 14

A polarizing film 14 was produced in the same manner as in Example 10 except that: the line width of the honeycomb structure of each of the first and second supports was set to 0.8 mm; and the length of one side of a regular hexagon of the honeycomb structure was set to 3.0 mm.

### Example 15

A polarizing film 15 was produced in the same manner as in Example 10 except that: the line width of the honeycomb structure of each of the first and second supports was set to 0.5 mm; and the length of one side of a regular hexagon of the honeycomb structure was set to 2.0 mm.

### Example 16

A polarizing film 16 was produced in the same manner as in Example 10 except that: the line width of the honeycomb structure of each of the first and second supports was set to 1.5 mm; and the length of one side of a regular hexagon of the honeycomb structure was set to 2 mm.

### Example 17

A polarizing film 17 was produced in the same manner as in Example 10 except that: the application agent E was applied by using a screen printing plate molded into a truss-like pattern (mesh size: #500, wire diameter: 18 μm, thickness: 38 μm, emulsion thickness: 10 μm); the structure of each of the first and second supports was turned into a truss structure (line width: 0.6 mm, length of one side of a triangle: 4.0 mm); and the second support was formed so that an apex of a triangle of the second support overlapped the center of a triangle of the first support in a plan view (the positions of the first support and the second support deviated from each other in a plan view).

### Example 18

A polarizing film 18 was produced in the same manner as in Example 17 except that: the line width of the truss structure of each of the first and second supports was set to 0.5 mm; and the length of one side of a triangle of the truss structure was set to 5.5 mm.

### Example 19

A polarizing film 19 was produced in the same manner as in Example 10 except that: the application agent E was applied by using a screen printing plate molded into a rigid-frame-like pattern (mesh size: #500, wire diameter: 18 μm, thickness: 38 μm, emulsion thickness: 10 μm); the structure of each of the first and second supports was turned into a rigid-frame structure (line width: 1.0 mm, length of one side of a square: 4.0 mm); and the second support was formed so that an apex of a square of the second support overlapped the center of a square of the first support in a plan view (the positions of the first support and the second support deviated from each other in a plan view).

### Example 20

A polarizing film 20 was produced in the same manner as in Example 19 except that: the line width of the rigid-frame structure of each of the first and second supports was set to 1.3 mm; and the length of one side of a square of the rigid-frame structure was set to 3.0 mm.

### Example 21

A polarizing film 21 was produced in the same manner as in Example 6 except that: the application agent E was applied by using a screen printing plate molded into a stripe-like pattern (mesh size: #500, wire diameter: 18 μm, thickness: 38 μm, emulsion thickness: 10 μm); the structure of each of the first and second supports was turned into a stripe structure extending in a direction perpendicular to the absorption axis of the polarizer (line width: 1.0 mm, stripe interval: 4.0 mm); and the second support was formed so as to overlap the first support in a plan view.

### Example 22

A polarizing film 22 was produced in the same manner as in Example 1 except that: the application agent F was used as an application agent; and the thickness of the support was set to 5 μm.

### Comparative Example 1

A surface protective film (manufactured by Nitto Denko Corporation, “RP301”) was bonded to the polarizer-side surface of the polarizer laminate A, and the amorphous PET substrate of the polarizer laminate A was peeled. After that, the surface protective film was peeled. Thus, a polarizing film 23 formed of the polarizer was produced.

### Comparative Example 2

A polarizing film 24 was produced in the same manner as in Example 21 except that the structure of each of the first and second supports was turned into a stripe structure extending in a direction parallel to the absorption axis of the polarizer.

### Comparative Example 3

The polarizer C was used as a polarizing film 25.

### Comparative Example 4

A UV-curable adhesive was prepared by mixing 40 parts by weight of N-hydroxyethyl acrylamide (HEAA), 60 parts by weight of acryloylmorpholine (ACMO), and 3 parts by weight of a photoinitiator (manufactured by BASF, “IRGACURE 819”).

The adhesive was applied to the polarizer-side surface of the polarizer laminate A so that its thickness after curing became 1 μm, and a protective film (thickness: 40 μm) obtained by subjecting the easy-adhesion-treated surface of a (meth)acrylic resin film having a lactone ring structure to corona treatment was bonded thereto. After that, the adhesive was irradiated with UV light serving as an active energy ray to be cured. A gallium-doped metal halide lamp (manufactured by Fusion UV Systems, Inc., product name: “Light HAMMER10”, bulb: V bulb, peak irradiance: 1,600 mW/cm², integrated irradiation quantity: 1,000 mJ/cm² (wavelength: 380 nm to 440 nm)) was used in the UV irradiation. The irradiance of the UV light was measured with a spectral irradiance meter (manufactured by Solatell Ltd., product name: “Sola-Check System”).

Next, the amorphous PET substrate of the polarizer laminate A was peeled. Thus, a polarizing film 26 including the polarizer and the protective film was produced.

### Comparative Example 5

A polarizing film 27 was produced in the same manner as in Comparative Example 4 except that a protective film (thickness: 20 μm) obtained by subjecting the easy-adhesion-treated surface of a (meth)acrylic resin film having a lactone ring structure to corona treatment was used as a protective film.

<Evaluations>

The polarizing films 1 to 27 were each subjected to the following adhesiveness test, torsion test, and U-shape folding test. The results of the evaluations are shown in Table 1.

<Adhesiveness Test>

The adhesiveness of a first support with a polarizer was measured in conformity with the cross-cut peeling test (number of grids: 100) of JIS K5400, and was evaluated by the following criteria.

∘: The number of peeled grids of the first support is 0.

x: The number of peeled grids of the first support is 1 or more.

<Torsion Test>

The torsion test was performed with a no-tension torsion testing machine for a planar object (product name: MAIN BODY TCDM111LH) and a jig (No-tension Torsion Test Jig for Planar Object) manufactured by Yuasa System Co., Ltd. The manner of the torsion test is illustrated in FIG. 9.

A polarizing film was cut out into a size measuring 120 mm (absorption axis direction) by 80 mm (transmission axis direction) to provide a sample for a test. Both short sides of the sample were sandwiched and fixed with the twisting clips 18 and 19 of the testing machine. After that, while one of the short sides was fixed with the clip 19, the clip 18 on the side of the other short side was twisted under the following conditions.

Twisting speed: 10 rpm

Twisting angle: 45°

Number of times of twisting: 100 times

The state of the sample after the torsion test was visually evaluated by the following criteria. In addition, when there was a sample that could not be measured for fracture and light leakage owing to its deformation or curling, the sample was judged to be unmeasurable.

∘: Fracture and light leakage did not occur. In addition, no bent mark remained.

Δ: Fracture and light leakage did not occur. However, a bent mark remained.

x: Fracture and light leakage occurred. In addition, a bent mark remained.

<U-Shape Folding Test>

The U-shape folding test was performed with a no-tension U-shape folding testing machine for a planar object (product name: MAIN BODY DLDM111LH) and a jig (No-tension U-shape Folding Test Jig for Planar Object) manufactured by Yuasa System Co., Ltd. The manner of the U-shape folding test is illustrated in FIG. 10.

A polarizing film was cut out into a size measuring 100 mm (absorption axis direction) by 50 mm (transmission axis direction) to provide a sample for a test. Both end portions x and y of the sample were fixed to the supporting portions 21 and 22 (clamping portions) of the testing machine with double-sided tapes (not shown). After that, such folding that one surface side (first surface) of the sample had an inward U-shape was performed under the following conditions to bend the sample. In the U-shape folding, a bending R (bending radius) was set to 3 mm, and the sample was bent from a planar state so as to be brought into a two-folded state. In the bending, both the end portions x and y were brought into contact with each other by the operation of the clamps, and the other portions of the sample were sandwiched between the plate portions 23 and 24, which were separately arranged, from both of their outsides without any tension.

In addition, in the bending by the folding, such folding that the other surface side (second surface) of the sample serving as a rectangular product had an inward U-shape was performed in the same manner as that described above.

Folding speed: 30 rpm

Bending R: 3 mm

Number of times of folding: 100 times

The state of the sample after the U-shape folding test was visually evaluated by the following criteria. In addition, when there was a sample that could not be measured for fracture and light leakage owing to its deformation or curling, the sample was judged to be unmeasurable.

∘: Fracture and light leakage did not occur. In addition, no bent mark remained.

x: Fracture or light leakage occurred. Alternatively, a bent mark was observed.

<Compressive Modulus of Elasticity of Support>

The compressive modulus of elasticity of a support at 23° C. was measured by the following procedure.

The application agent A was applied to the polarizer-side surface of the polarizer laminate A so that its thickness after curing became 5 μm, followed by its drying under the conditions of 60° C. and 120 seconds. Thus, a sample A in which a layer of a cured product (solidified product) formed of the application agent A was formed on the polarizer laminate A was produced. Samples B to F were similarly produced by using the application agents B to F. The measurement of compressive moduli of elasticity was performed with the produced samples A to F by the following method, and values for the compressive moduli of elasticity obtained by the measurement were defined as the compressive moduli of elasticity of supports A to F at 23° C.

TI900 TriboIndenter (manufactured by Hysitron, Inc.) was used in the measurement of the compressive moduli of elasticity.

Each of the samples obtained in the foregoing was cut into a size measuring 10 mm by 10 mm, and was fixed to a support mounted on the TriboIndenter, followed by the measurement of its compressive modulus of elasticity by a nanoindentation method. At that time, the position of an indenter to be used was adjusted so that the indenter was indented into the vicinity of the central portion of the cured product. Measurement conditions are described below.

Indenter to be used: Berkovich (triangular pyramid type)

Measurement method: Single indentation measurement

Measurement temperature: 23° C.

Indentation depth setting: 100 nm

The compressive moduli of elasticity of the supports A to F at 23° C. were as described below.

Support A (application agent A): 2.57 GPa

Support B (application agent B): 0.84 GPa

Support C (application agent C): 0.07 GPa

Support D (application agent D): 0.42 GPa

Support E (application agent E): 0.02 GPa

Support F (application agent F): 5.38 GPa

TABLE 1

| | | Protec- | | | | | | | | | | |
|---|---|---|---|---|---|---|---|---|---|---|---|---|
| | Polar- | tive | Support | | | | | | | | | |
| | izer | film | | | | Length | Thickness | Thickness | Position of | | | |
| | thick- | thick- | | | Line | of one | of first | of second | second support | Test | | |
| | ness | ness | | Pattern | width | side | support | support | with respect t∘ | Adhesive- | | U-shape |
| | (μm) | (μm) | Material | structure | (mm) | (mm) | (μm) | (μm) | first support | ness | Torsion | folding |
| Example 1 | 5 | — | Application | Honeycomb | 1.0 | 4.0 | 7 | — | — | ∘ | ∘ | ∘ |
| | | | agent A | | | | | | | | | |
| Example 2 | 5 | — | Application | Honeycomb | 1.0 | 4.0 | 7 | — | — | ∘ | ∘ | ∘ |
| | | | agent B | | | | | | | | | |
| Example 3 | 5 | — | Application | Honeycomb | 1.0 | 4.0 | 7 | — | — | ∘ | ∘ | ∘ |
| | | | agent C | | | | | | | | | |
| Example 4 | 5 | — | Application | Honeycomb | 1.0 | 4.0 | 7 | — | — | ∘ | ∘ | ∘ |
| | | | agent D | | | | | | | | | |
| Example 5 | 5 | — | Application | Honeycomb | 1.0 | 4.0 | 7 | — | — | ∘ | ∘ | ∘ |
| | | | agent E | | | | | | | | | |
| Example 6 | 5 | — | Application | Honeycomb | 1.0 | 4.0 | 7 | 7 | Overlapping | ∘ | ∘ | ∘ |
| | | | agent E | | | | | | each other in | | | |
| | | | | | | | | | plan view | | | |
| Example 7 | 5 | — | Application | Honeycomb | 1.0 | 4.0 | 3 | 3 | Overlapping | ∘ | ∘ | ∘ |
| | | | agent E | | | | | | each other in | | | |
| | | | | | | | | | plan view | | | |
| Example 8 | 5 | — | Application | Honeycomb | 1.0 | 4.0 | 5 | 5 | Overlapping | ∘ | ∘ | ∘ |
| | | | agent E | | | | | | each other in | | | |
| | | | | | | | | | plan view | | | |
| Example 9 | 5 | — | Application | Honeycomb | 1.0 | 4.0 | 14 | 14 | Overlapping | ∘ | ∘ | ∘ |
| | | | agent E | | | | | | each other in | | | |
| | | | | | | | | | plan view | | | |
| Example 10 | 5 | — | Application | Honeycomb | 1.0 | 4.0 | 7 | 7 | Deviated from | ∘ | ∘ | ∘ |
| | | | agent E | | | | | | each other | | | |
| Example 11 | 7 | — | Application | Honeycomb | 1.0 | 4.0 | 7 | 7 | Deviated from | ∘ | ∘ | ∘ |
| | | | agent E | | | | | | each other | | | |
| Example 12 | 12 | — | Application | Honeycomb | 1.0 | 4.0 | 7 | 7 | Deviated from | ∘ | ∘ | ∘ |
| | | | agent E | | | | | | each other | | | |
| Example 13 | 5 | — | Application | Honeycomb | 1.8 | 4.0 | 7 | 7 | Deviated from | ∘ | ∘ | ∘ |
| | | | agent E | | | | | | each other | | | |
| Example 14 | 5 | — | Application | Honeycomb | 0.8 | 3.0 | 7 | 7 | Deviated from | ∘ | ∘ | ∘ |
| | | | agent E | | | | | | each other | | | |
| Example 15 | 5 | — | Application | Honeycomb | 0.5 | 2.0 | 7 | 7 | Deviated from | ∘ | ∘ | ∘ |
| | | | agent E | | | | | | each other | | | |
| Example 16 | 5 | — | Application | Honeycomb | 1.5 | 2.0 | 7 | 7 | Deviated from | ∘ | ∘ | ∘ |
| | | | agent E | | | | | | each other | | | |
| Example 17 | 5 | — | Application | Truss | 0.6 | 4.0 | 7 | 7 | Deviated from | ∘ | ∘ | ∘ |
| | | | agent E | | | | | | each other | | | |
| Example 18 | 5 | — | Application | Truss | 0.5 | 5.5 | 7 | 7 | Deviated from | ∘ | ∘ | ∘ |
| | | | agent E | | | | | | each other | | | |
| Example 19 | 5 | — | Application | Rigid | 1.0 | 4.0 | 7 | 7 | Deviated from | ∘ | ∘ | ∘ |
| | | | agent E | frame | | | | | each other | | | |
| Example 20 | 5 | — | Application | Rigid | 1.3 | 3.0 | 7 | 7 | Deviated from | ∘ | ∘ | ∘ |
| | | | agent E | frame | | | | | each other | | | |
| Example 21 | 5 | — | Application | Stripe | 1.0 | Line | 7 | 7 | Overlapping | ∘ | ∘ | ∘ |
| | | | agent E | (perpen- | | interval: | | | each other in | | | |
| | | | | dicular to | | 4.0 | | | plan view | | | |
| | | | | absorption | | | | | | | | |
| | | | | axis) | | | | | | | | |
| Example 22 | 5 | — | Application | Honeycomb | 1.0 | 4.0 | 5 | — | — | ∘ | ∘ | ∘ |
| | | | agent F | | | | | | | | | |
| Comparative | 5 | — | — | — | — | — | — | — | — | — | Unmea- | Unmea- |
| Example 1 | | | | | | | | | | | surable | surable |
| Comparative | 5 | — | Application | Stripe | 1.0 | Line | 7 | 7 | Overlapping | ∘ | Unmea- | Unmea- |
| Example 2 | | | agent E | (parallel | | interval: | | | each other in | | surable | surable |
| | | | | to | | 4.0 | | | plan view | | | |
| | | | | absorption | | | | | | | | |
| | | | | axis) | | | | | | | | |
| Comparative | 12 | — | — | — | — | — | — | — | — | — | Unmea- | Unmea- |
| Example 3 | | | | | | | | | | | surable | surable |
| Comparative | 5 | 40 | — | — | — | — | — | — | — | — | x | ∘ |
| Example 4 | | | | | | | | | | | | |
| Comparative | 5 | 20 | — | — | — | — | — | — | — | — | x | ∘ |
| Example 5 | | | | | | | | | | | | |

As is apparent from Table 1, the handleability (self-supportability) of each of the polarizing films of Comparative Examples 1 to 3 was so low that the torsion test and the U-shape folding test could not be performed. In addition, in each of the polarizing films of Comparative Examples 4 and 5, fracture and light leakage occurred, and a bent mark remained.

In contrast, the polarizing films of Examples 1 to 22 showed satisfactory results in each of the evaluations, i.e., the adhesiveness test, the torsion test, and the U-shape folding test.

The polarizing film of the present invention is suitably used in an image display apparatus, such as a liquid crystal display apparatus or an organic EL display apparatus.

What is claimed is:

1. A polarizing film, comprising:
a polarizer; and
a support formed on at least one surface of the polarizer,
wherein the support has a pattern structure.

2. The polarizing film according to claim 1, wherein the polarizer has a thickness of 15 μm or less.

3. The polarizing film according to claim 1, wherein the support has at least one structure selected from the group consisting of a honeycomb structure, a truss structure, a rigid-frame structure, a stripe structure, and a circle structure.

4. The polarizing film according to claim 1, wherein the support has a thickness of from 1 μm to 15 μm.

5. The polarizing film according to claim 1, wherein the support has a width in a plan view of from 500 μm to 3,000 μm.

6. The polarizing film according to claim 1, wherein the support has optical isotropy.

7. The polarizing film according to claim 1, further comprising, on the one surface of the polarizer, an embedding resin layer configured to embed the support therein.

8. The polarizing film according to claim 1, wherein the support has a compressive modulus of elasticity at 23° C. of from 0.01 GPa to 8.0 GPa.

9. An image display apparatus, comprising the polarizing film of claim 1.

10. A method of producing a polarizing film, comprising:
forming a pattern of a resin material on at least one surface of a polarizer; and
curing the resin material to provide a support having a pattern structure.
